(19) United States
(12) Patent Application Publication
(10) Pub. No.: US 2010/0257364 A1
(43) Pub. Date: Oct. 7, 2010

(54) Apparatus and method for processing authentication of handover ranging message in wireless communication system

(75) Inventors: Young-Kyo Baek, Seoul (KR); Hyun-Jeong Kang, Seoul (KR); Jae-Hyuk Jang, Suwon-si (KR); Jung-Je Son, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/798,402

(22) Filed: Apr. 2, 2010

(30) Foreign Application Priority Data
Apr. 2, 2009 (KR) 10-2009-0028327

(51) Int. Cl. H04W 12/06; H04L 9/08

(52) U.S. Cl. 713/170; 380/272; 380/44; 380/279

(57) ABSTRACT

A base station includes an apparatus for protecting information of a mobile station during a process of authenticating a ranging message of the mobile station that performs a handover in a wireless communication, system. In a method for encrypting a ranging response message in a base station, when a ranging request message is received from a mobile station that performs a handover, an authentication station is requested to transmit Authorization Key (AK) context of the mobile station. Validity of the ranging request message is determined using CMAC based on the AK context of the mobile station provided by the authentication station. When the ranging request message is valid, a response message to the ranging request message is encrypted. The encrypted response message is transmitted to the mobile station.

### CROSS REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Apr. 2, 2009 and assigned Serial No. 10-2009-0028327, the entire disclosure of which is hereby incorporated by reference.

### TECHNICAL FIELD OF THE INVENTION

The present invention relates to a handover of a mobile station in a wireless communication system. More particularly, the present invention relates to an apparatus and a method for encrypting a handover ranging response message at a base station and transmitting the handover ranging response message to a mobile station in a wireless communication system.

### BACKGROUND OF THE INVENTION

A cellular based wireless communication system supports a handover in order to provide a service to a mobile station without interruption.

The handover denotes a technique for, when a mobile station moves from a service area of a serving base station to a service area of a neighbor base station, changing connection formed between the serving base station and the mobile station to connection between the neighbor base station to which the mobile station has moved and the mobile station.

When a mobile station that receives a service from a serving base station performs a handover to a target base station, the mobile station performs a ranging procedure with the target base station in order to access the target base station.

As described above, in the case where the mobile station performs a ranging procedure with the target base station through a handover, the mobile station may determine identifier information of the mobile station allocated by the target base station from a ranging response message provided from the target base station. However, the ranging response message is transmitted in the form of an unencrypted plaintext. Accordingly, information of the mobile station is easily exposed.

### SUMMARY OF THE INVENTION

To address the above-discussed deficiencies of the prior art, it is a primary object to provide at least the advantages described below. Accordingly, an aspect of the present invention is to provide an apparatus and a method for protecting information of a mobile station during a process for authenticating a ranging message of the mobile station that performs a handover in a wireless communication system.

Another aspect of the present invention is to provide an apparatus and a method for protecting information of a mobile station during a process for authenticating a ranging message of the mobile station that performs a handover between networks of the same kind in a wireless communication system.

Still another aspect of the present invention is to provide an apparatus and a method for protecting information of a mobile station during a process for authenticating a ranging message of the mobile station that performs a handover between networks of different kinds in a wireless communication system.

Yet another aspect of the present invention is to provide an apparatus and a method for encrypting a ranging response message at a base station and transmitting the same to a mobile station that performs a handover in a wireless communication system.

In accordance with an aspect of the present invention, a method for authenticating a ranging message at a mobile station of a wireless communication system is provided. The method includes requesting ranging to a base station to be accessed through a handover, when an encrypted ranging response message is received from the base station, determining validity of the encrypted ranging response message using an Integrity Check Value (ICV) of the encrypted ranging response message, and when the encrypted ranging response message is valid, decoding the encrypted ranging response message.

In accordance with another aspect of the present invention, a method for authenticating a ranging message at a base station of a wireless communication system is provided. The method includes, when a ranging request message is received from a mobile station that has requested a handover, requesting an authentication station to transmit Authorization Key (AK) context of the mobile station, when the AK context for the mobile station is received from the authentication station, determining validity of the ranging request message using CMAC based on the AK context, when the ranging request message is valid, encrypting a response message to the ranging request message, and transmitting the encrypted response message to the mobile station.

In accordance with further another aspect of the present invention, an apparatus for authenticating a ranging message at a mobile station of a wireless communication system is provided. The apparatus includes a transmitter that transmits a ranging request message to a base station to be accessed through a handover, a receiver that receives a signal from the base station, a data processor that, when an encrypted ranging response message is received via the receiver, determines validity of the encrypted ranging response message using an Integrity Check Value (ICV) of the encrypted ranging response message, and a controller that controls transmission of a ranging request message to the base station, and determines whether a handover to the base station is completed depending on validity of the ranging response message determined by the data processor.

In accordance with further another aspect of the present invention, an apparatus that authenticates a ranging message at a base station of a wireless communication system is provided. The apparatus includes a receiver that receives a signal; a transmitter that transmits a signal, a wired interface that performs communication with an authentication station, a message authenticator that, when a ranging request message is received from a mobile station through the receiver, request an AK context of the mobile station, determines validity of the ranging request message using CMAC based on Authorization Key (AK) context of the mobile station provided from the authentication station, the controller that obtains the AK context of the mobile station from the authentication station via the wired interface in response to a request of the message authenticator, and when the message authenticator determines the ranging request message is valid, controls to transmit a ranging response message to the mobile station, and a data generator that encrypts a ranging response message provided from the message authenticator and transmits the same to the mobile station via the transmitter under control of the controller.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an authentication procedure of a mobile station that performs a handover in a wireless communication system according to an exemplary embodiment of the present invention;

FIG. 2 illustrates a procedure for receiving, at a mobile station, authentication from a target base station in a wireless communication system according to an exemplary embodiment of the present invention;

FIG. 3 illustrates a procedure for authenticating, at a base station, a mobile station that performs a handover in a wireless communication system according to an exemplary embodiment of the present invention;

FIG. 4 illustrates an authentication procedure of a mobile station that performs a handover in a wireless communication system according to an exemplary embodiment of the present invention;

FIG. 5 illustrates a procedure for receiving, at a mobile station, authentication from a target base station in a wireless communication system according to an exemplary embodiment of the present invention;

FIG. 6 illustrates a procedure for authenticating, at a base station, a mobile station that performs a handover in a wireless communication system according to an exemplary embodiment of the present invention;

FIG. 7 illustrates a mobile station in a wireless communication system according to an exemplary embodiment of the present invention;

FIG. 8 illustrates a base station in a wireless communication system according to an exemplary embodiment of the present invention; and

FIGS. 9A and 9B illustrate a construction of an encrypted packet according to an exemplary embodiment of the present invention.

Throughout the drawings, like reference numerals will be understood to refer to like parts, components and structures.

### DETAILED DESCRIPTION OF THE INVENTION

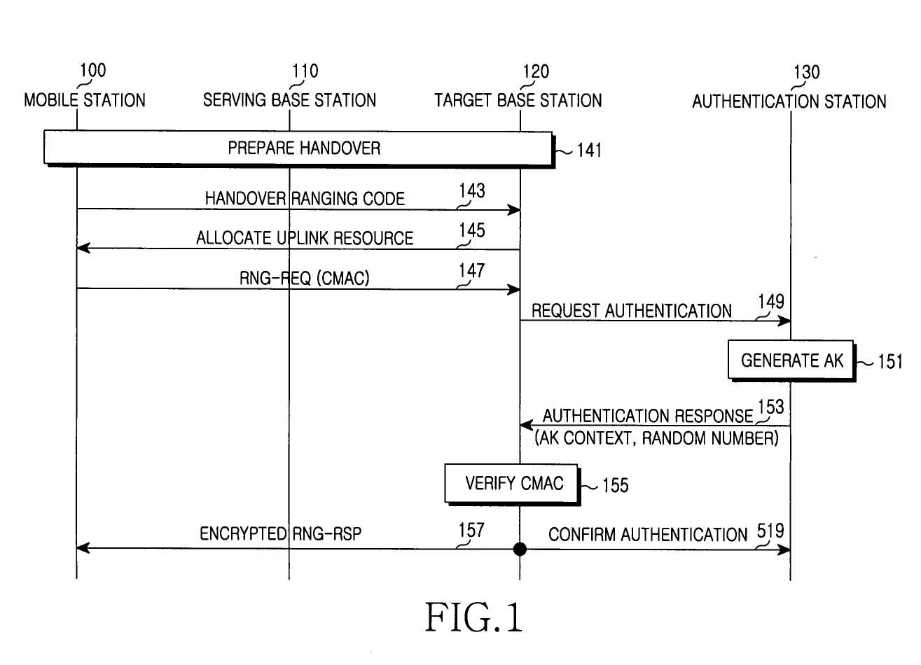

FIGS. 1 through 9B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Preferred embodiments of the present invention will be described herein below with reference to the accompanying drawings. In the following description, well-known functions or constructions are not described in detail since they would obscure the invention in unnecessary detail. Terms described below, which are defined considering functions in the present invention, can be different depending on user and operator's intention or practice. Therefore, the terms should be defined on the basis of the disclosure throughout this specification.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

Exemplary embodiments of the present invention provide a technique for protecting information of a mobile station during a process for authenticating a ranging message of a mobile station that performs a handover in a wireless communication system.

An exemplary embodiment of the present invention is described using an Orthogonal Frequency Division Multiplexing (OFDM)/Orthogonal Frequency Division Multiple Access (OFDMA)-based wireless communication system as an example, but is applicable to a system of a different communication scheme that performs a handover of a mobile station similarly to the present invention.

During a process for authenticating a ranging message of a mobile station that performs a handover, a base station of a wireless communication system encrypts a ranging response message as illustrated in FIG. 1 in order to protect information of the mobile station, and transmits the same to the mobile station.

FIG. 1 illustrates an authentication procedure of a mobile station that performs a handover in a wireless communication system according to an exemplary embodiment of the present invention.

Referring to FIG. 1, in the case where the mobile station 100 that has received a service from a serving base station 110 performs a handover to a target base station 120, the mobile station 100 may obtain information required for communication with the target base station 120 through a handover preparation procedure with the serving base station 110 and the target base station 120 in step 141. For example, the mobile station 100 and the serving base station 110 collect information of base stations that can support a handover of the mobile station 100 among neighbor base stations, and select the target base station 120 to which the mobile station 100 is to perform a handover. Here, the information required for communication with the target base station 120 includes a ranging code that has been allocated by the target base station 120.

The mobile station 100 transmits a ranging request code representing a handover to the target base station 120 in order to access the target base station 120 in step 143. For example, the mobile station 100 transmits a ranging code allocated by the target base station 120 to the target base station 120 via a resource allocated by the target base station 120. For example, the mobile station 100 may transmit a ranging code representing a handover to the target base station 120 via a shared resource used in common by mobile stations that try a handover. That is, the mobile station 100 transmits an arbitrarily selected handover ranging code to the target base station 120 through a handover ranging region.

When a ranging code representing a handover is received without an error, the target base station 120 detects an access trial of the mobile station 100. Accordingly, the target base station 120 allocates an uplink resource to the mobile station 100 so that the mobile station 100 may transmit information required for the access in step 145.

The mobile station 100 transmits a handover ranging request message RNG-REQ to the target base station 120 using the uplink resource allocated by the target base station 120 in step 147. At this point, the handover ranging request message RNG-REQ includes identifier information of the mobile station 100 and a Cipher-based Message Authorization Code (CMAC) for authenticating this RNG-REQ message. Here, the identifier information of the mobile station 100 includes at least one of a Media Access Control (MAC) address of the mobile station 100, a pseudo MAC address of the mobile station 100, and a Station Identifier (STID) of the mobile station 100. The pseudo MAC address denotes an identification value of the mobile station 100 allocated by an authentication station 130 during a process of initial opening and authentication of the mobile station 100 so that an actual MAC address of the mobile station 100 is not exposed. In addition, the mobile station 100 generates a CMAC using an Authorization Key (AK) generated using an MAC address of the mobile station 100 and a Base Station Identification (BSID) information of the target base station.

When the handover ranging request message is received, the target base station 120 requests the authentication station 130 to transmit AK context of the mobile station 100 in step 149.

The authentication station 130 generates an AK of the mobile station 100 using PMK based on an MSK obtained through the EAP with the mobile station 100, the MAC address of the mobile station 100, and the BSID information of the target base station 120 in step 151. The authentication station 130 transmits an authentication response message including the generated AK context and a Traffic Encryption Key (TEK) generation variable for encryption communication with the mobile station 100, to the target base station 120 in step 153. Here, the AK context includes an AK, an AK ID, and AK_COUNT. In addition, the TEK generation variable includes a random number.

The target base station 120 determines whether a CMAC provided by the mobile station 100 is valid using the AK context included in the authentication response message in step 155.

When the CMAC is valid, the target base station 120 determines that the mobile station 100 has been authenticated. Accordingly, the target base station 120 generates a TEK using the AK context and the TEK generation variable included in the authentication response message. For example, the target base station 120 generates the TEK using an AK, a random number, AK_COUNT, a security association ID, a BSID, an MAC address of the mobile station, etc.

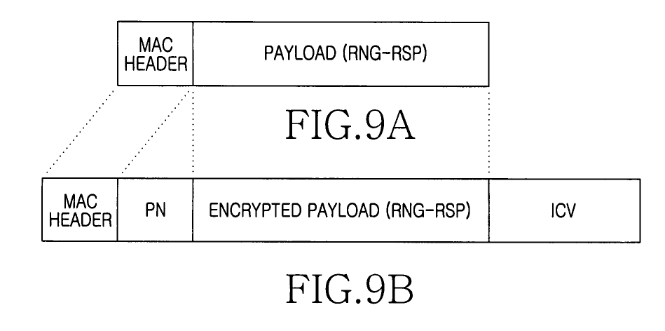

After that, the target base station 120 encrypts a handover ranging response message RNG-RSP using the TEK. At this point, the target base station 120 encrypts the handover ranging response message using an encryption technique including an encrypting function using the TEK and an authentication function. For example, the target base station 120 encrypts the handover ranging response message using an Advanced Encryption Standard CTR mode with CBC-MAC (AES-CCM) technique (CTR (CounTeR), CBC-MAC (Cipher-Block Chaining Message Authorization Code)) that uses the TEK. In the case of encrypting a handover ranging response message formed in FIG. 9A using the AES-CCM technique, the target base station 120 generates an ICV of the handover ranging response message using the TEK and an initial input variable. Also, the target base station 120 encrypts a planetext payload including a handover ranging response message using the TEK and the initial input variable. Here, the initial input variable includes an MAC header, a Packet Number (PN), length information of a payload to be encrypted.

The target base station 120 transmits the encrypted handover ranging response message to the mobile station 100 in step 157. For example, the target base station 120 transmits the encrypted handover ranging response message illustrated in FIG. 9B to the mobile station 100. At this point, the target base station 120 transmits the encrypted handover ranging response message to the mobile station 100 using an STID allocated to the mobile station 100 during the handover preparation procedure, or an STID for ranging used during a network initial access.

The target base station 120 transmits authentication confirmation information of the mobile station 100 to the authentication station 130 in step 159.

The mobile station 100 determines whether an encrypted handover ranging response message is received from the target base station 120. For example, the mobile station 100 determines whether an encrypted handover ranging response message is received using an STID allocated by the target base station 120 during the handover preparation procedure. For example, the mobile station 100 determines whether an encrypted handover ranging response message is received using an STID for ranging used during a network initial access.

The mobile station 100 determines validity of an encrypted handover ranging response message provided by the target base station 120. For example, the mobile station 100 determines whether an encrypted payload is valid using an ICV included in the encrypted handover ranging response message provided by the target base station 120.

When the encrypted payload is valid, the mobile station 100 decodes the encrypted payload. That is, when the encrypted handover ranging response message is valid, the mobile station 100 decodes the handover ranging response message. After that, the mobile station 100 determines information for communication with the target base station 120 from the decoded handover ranging response message, and completes a handover.

In contrast, when the CMAC is invalid in step 155, the target base station 120 instructs the mobile station 100 to perform a network re-entry. After that, the target base station 120 and the mobile station 100 perform a network re-entry procedure.

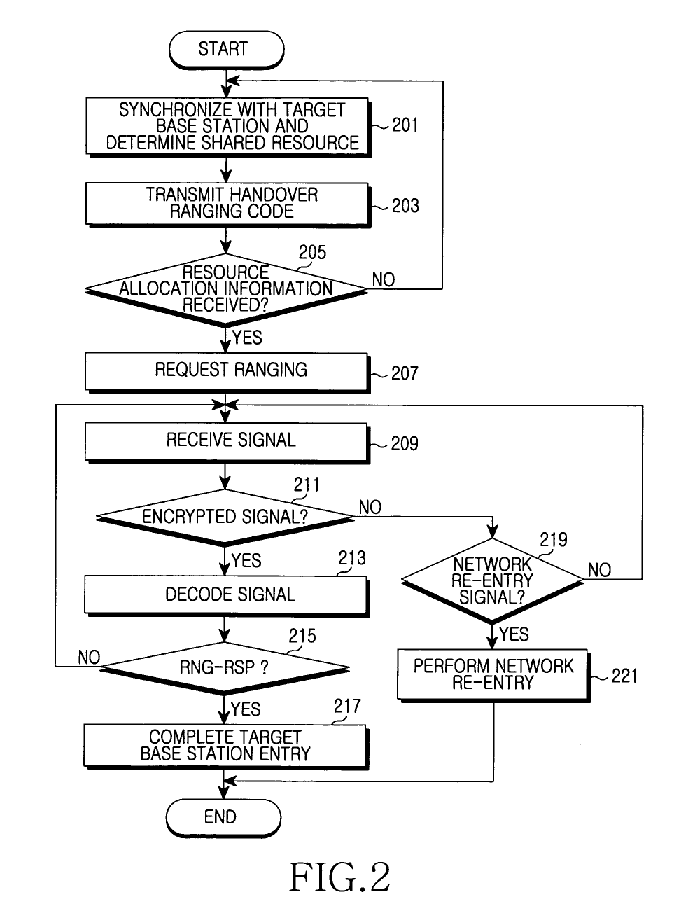

In the case of performing the above-described ranging message authentication procedure, the mobile station operates as illustrated in FIG. 2. Here, it is assumed that a mobile station performs an operation for accessing a target base station selected by the mobile station or a serving base station.

FIG. 2 illustrates a procedure for receiving, at a mobile station, authentication from a target base station in a wireless communication system according to an exemplary embodiment of the present invention.

Referring to FIG. 2, the mobile station determines a resource for synchronization with a target base station accessed through a handover and transmitting a ranging code in step 201. For example, the mobile station obtains information required for communication with the target base station through a handover preparation procedure (step 141) with the serving base station and the target base station illustrated in FIG. 1.

The mobile station transmits a handover ranging code to the target base station in step 203. For example, the mobile station transmits a ranging code allocated by the target base station through the handover preparation procedure to the target base station. For example, the mobile station may transmit a ranging code representing a handover to the target base station via a shared resource used in common by mobile stations that try a handover. That is, the mobile station transmits an arbitrarily selected handover ranging code to the target base station through a handover ranging region.

After transmitting the handover ranging code, the mobile station determines whether resource allocation information is received from the target base station in step 205. For example, the mobile station determines whether a handover ranging code response message including an uplink resource allocation information UL MAP JE is received.

When the resource allocation information is not received from the target base station within a set time, the mobile station returns to step 201 and determines again a resource for synchronization with the target base station and transmitting a ranging code. At this point, when transmitting the handover ranging code more than a reference transmission frequency, the mobile station may recognize that an access to the target base station has failed.

When the resource allocation information is received from the target base station within the set time, the mobile station transmits a handover ranging request message RNG-REQ to the target base station using an uplink resource determined from the resource allocation information in step 207. Here, the handover ranging request message RNG-REQ includes STID information of the mobile station and a CMAC for authenticating this RNG-REQ message. At this point, the mobile station generates the CMAC using an AK generated using PMK based on an MSK obtained through an EAP, an MAC address of the mobile station, and BSID information of the target base station. In addition, the STID information of the mobile station includes at least one of a Media Access Control (MAC) address of the mobile station, a pseudo MAC address of the mobile station, and an STID of the mobile station.

After transmitting a handover ranging request message to the target base station, the mobile station receives a signal from the target base station in step 209. For example, the mobile station receives a signal from the target base station using an STID allocated by the target base station during a handover preparation procedure, or an STID for ranging used during a network initial access.

The mobile station determines whether the signal received from the target base station is an encrypted signal in step 211. For example, the mobile station determines whether the signal received from the target base station is an encrypted signal using header information of the received signal.

When the signal received from the target base station is an encrypted signal, the mobile station decodes the encrypted signal in step 213. For example, the mobile station determines whether the signal is valid using an ICV included in the encrypted signal. When the encrypted signal is valid, the mobile station decodes the encrypted signal. In contrast, when the encrypted signal is invalid, the mobile station discards the signal.

After decoding the encrypted signal, the mobile station determines whether the decoded signal is a handover ranging response message in step 215.

When the decoded signal is not the handover ranging response message, the mobile station returns to step 209 and receives another signal from the target base station.

In contrast, when the decoded signal is the handover ranging response message, the mobile station recognizes that entry to the target base station has been successful and the handover has been completed in step 217.

When the signal received from the target base station is an unencrypted signal in step 211, the mobile station determines whether a signal received from the target base station is a network re-entry indicate signal in step 219.

When the signal received from the target base station is not a network re-entry indicate signal, the mobile station returns to step 209 and receives another signal from the target base station.

In contrast, when the signal received from the target base station is a network re-entry indicate signal, the mobile station performs a network re-entry procedure for the target base station in step 221.

After that, the mobile station ends the process.

Hereinafter, a method for operating a base station for encrypting a ranging response message and transmitting the same to a mobile station is described.

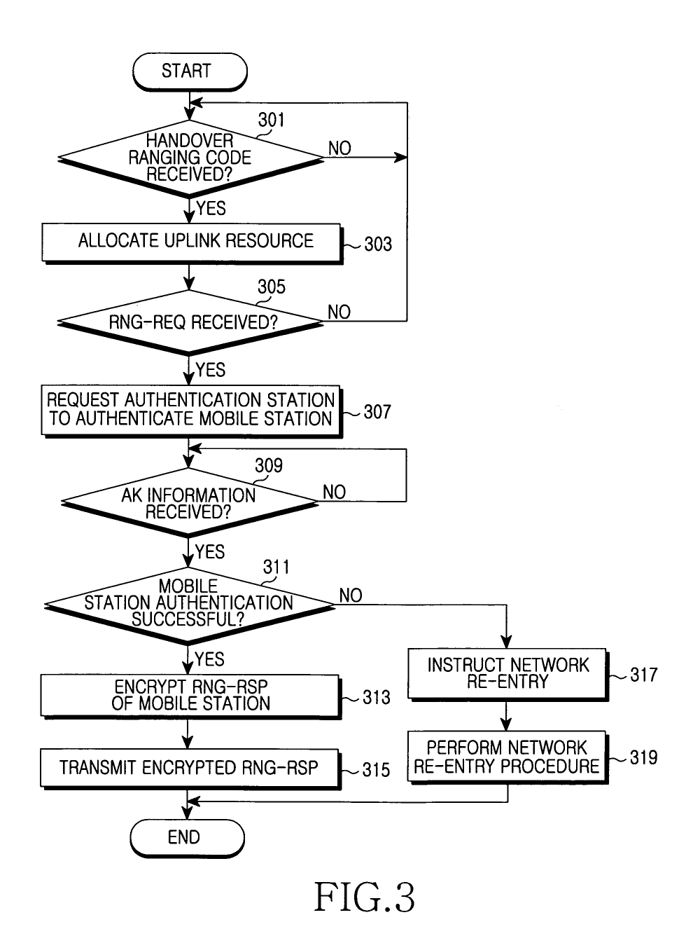

FIG. 3 illustrates a procedure for authenticating, at a base station, a mobile station that performs a handover in a wireless communication system according to an exemplary embodiment of the present invention.

Referring to FIG. 3, the base station determines whether a handover ranging code is received from a mobile station that newly accesses through a handover in step 301. For example, the base station determines whether a ranging code allocated to the mobile station through a handover preparation procedure is received. In this case, the base station determines whether the ranging code is received via a resource allocated to the mobile station. For example, the base station may determine whether a ranging code is received via a shard resource used for mobile stations that try an arbitrary access.

When a handover ranging code is received from the mobile station, the base station allocates an uplink resource to the mobile station so that the mobile station may transmit information required for an access in step 303.

The base station determines whether a handover ranging request message is received via the resource allocated to the mobile station in step 305. At this point, the handover ranging request message includes an STID information of the mobile station and a CMAC for authenticating the RNG-REQ message.

When a handover ranging request message is not received within a set time, the base station determines an error has occurred. Accordingly, the base station returns to step 301 and determines whether a handover ranging request message is received again. At this point, when the handover ranging request message is not received more than a reference transmission frequency, the base station may recognize that an access of the mobile station has failed.

In contrast, when the handover ranging request message is received within a set time, the base station requests an authentication station to transmit AK context of the mobile station that has requested the handover ranging in step 307.

The base station determines whether an AK response message including the AK context of the mobile station and a TEK generation variable for encryption communication with the mobile station is received from the authentication station in step 309. Here, the AK context includes an AK, an AK ID, and AK_COUNT. In addition, the TEK generation variable includes a random number.

When the AK response message is received from the authentication station, the base station determines whether a CMAC provided by the mobile station is valid using the AK context included in the authentication response message in step 311.

When the CMAC is invalid, the base station determines that the mobile station cannot be authenticated. Accordingly, the base station instructs the mobile station to perform network re-entry in step 317.

The base station performs a network re-entry procedure of the mobile station in step 319.

In contrast, when the CMAC is valid in step 311, the base station determines that the mobile station is authenticated. Accordingly, the base station encrypts a handover ranging response message using the AK context and the TEK generation variable included in the authentication response message in step 313. For example, the base station generates a TEK using an AK, a random number, AK_COUNT, a security association ID, a BSID, a MAC address of the mobile station, and the like. After that, the base station encrypts a handover ranging response message using an AES-CCM technique that uses the TEK. That is, the base station generates an ICV of the handover ranging response message using the TEK and an initial input variable. In addition, the base station encrypts a plaintext payload including the handover ranging response message using the TEK and the initial input variable. Here, the initial input variable includes a MAC header, a PN, length information of a payload to be encrypted, and the like.

After encrypting the handover ranging response message, the base station transmits the encrypted handover ranging response message to the mobile station in step 315. For example, the base station transmits the encrypted handover ranging response message to the mobile station using an STID allocated to the mobile station during the handover preparation procedure, or an STID for ranging used during a network initial access.

At this point, though not shown, the base station transmits authentication confirmation information of the mobile station to the authentication station.

After that, the base station ends the process.

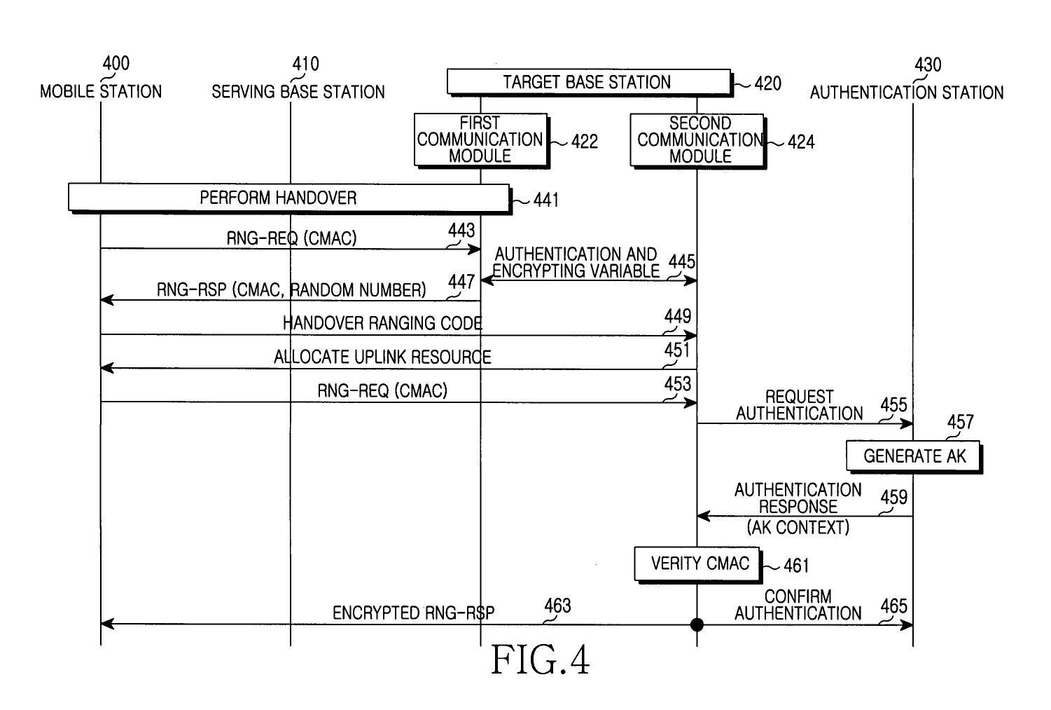

In the above embodiment, the serving base station of the mobile station that performs a handover and the target base station form a similar network. In the case where the serving base station of the mobile station that performs a handover and the target base station form networks of different kinds, a wireless communication system encrypts a ranging response message and transmits the same to the mobile station as illustrated in FIG. 4.

FIG. 4 illustrates an authentication procedure of a mobile station that performs a handover in a wireless communication system according to an exemplary embodiment of the present invention. In the following description, it is assumed that a serving base station 410, a first communication module 422 of a target base station form the same network.

As illustrated in FIG. 4, in the case where a mobile station 400 that has received a service from the serving base station 410 performs a handover to a second communication module 424 of the target base station 420, the mobile station 400 performs a handover from the serving base station 410 to the first communication module 422 of the target base station 420 in step 441.

The mobile station 400 transmits a zone switching ranging request message to the first communication module 422 in order to perform zone switching to the second communication module 424 in step 443. Here, the zone switching ranging request message includes a CMAC. In addition, the zone switching ranging request message is the same as a handover ranging request message in a network of the same kind.

When a zone switching ranging request message is normally received from the mobile station 400 without an error, the first communication module 422 obtains information required for authentication and encryption from the second communication module 424 in step 445. Here, information required for the authentication and the encryption includes random number information.

The first communication module 422 transmits a zone switching ranging response message including the information required for the authentication and the encryption, and the CMAC to the mobile station 400 in step 447. Here, the zone switching ranging response message is the same as a handover ranging response message in a network of the same kind.

The mobile station 400 may obtain information required for communication with the second communication module 424 through the zone switching ranging response message provided by the first communication module 422. Here, the information required for communication with the second communication module 424 includes a ranging code allocated by the second communication module 424.

The mobile station 400 transmits a ranging request code representing zone switching to the second communication module 424 in step 449. For example, the mobile station 400 transmits a ranging code allocated via the zone switching ranging response message by the second communication module 424 to the second communication module 424. In this case, the mobile station 400 transmits the ranging code via a resource allocated by the second communication module 424. For example, the mobile station 400 may transmit a ranging code representing a handover to the second communication module 424 via a shared resource used in common for mobile stations that try a handover. That is, the mobile station 400 transmits an arbitrarily selected zone switching ranging code to the second communication module 424 via a zone switching ranging region.

When a ranging code representing zone switching is normally received, the second communication module 424 detects an access trial of the mobile station 400. Accordingly, the second communication module 424 allocates an uplink resource to the mobile station 400 so that the mobile station 400 may transmit information required for an access in step 451.

The mobile station 400 transmits a zone switching ranging request message RNG-REQ to the second communication module 424 using the uplink resource allocated by the second communication module 424 in step 453. Here, the zone switching ranging request message includes STID information of the mobile station 400 and a CMAC for authenticating the RNG-REQ message. At this point, the mobile station 400 generates the CMAC using an AK generated using PTAK based on an MSK obtained through an EAP, an MAC address of the mobile station, and BSID information of the second communication module 424. In addition, the STID information of the mobile station 400 includes at least one of a Media Access Control (MAC) address of the mobile station 400, a pseudo MAC address of the mobile station 400, and an STID of the mobile station 400.

When the zone switching ranging request message is received, the second communication module 424 requests an authentication station 430 to transmit AK context of the mobile station in step 455.

The authentication station 430 generates an AK of the mobile station 400 using an MSK obtained through an EAP with the mobile station 400, an MAC address of the mobile station 400, and BSID information of the second communication module 424 in response to the AK information request for the mobile station 400 in step 457. The authentication station 430 transmits an AK response message including the generated AK context to the second communication module 424 in step 459. Here, the AK context includes an AK, an AK ID, and AK_COUNT.

The second communication module 424 determines whether a CMAC provided by the mobile station 400 is valid using the AK context included in the AK response message in step 461.

When the CMAC is valid, the second communication module 424 determines that the mobile station 400 has been authenticated. Accordingly, the second communication module 424 generates a TEK using the AK context included in the AK response message and the TEK variable generation variable transmitted (in step 445) to the first communication module 422. For example, the second communication module 424 generates the TEK using an AK, a random number, AK_COUNT, a security association ID, a BSID, a MAC address of the mobile station, and the like.

After that, the second communication module 424 encrypts a zone switching ranging response message RNG-RSP using the TEK. At this point, the second communication module 424 encrypts a zone switching ranging response message RNG-RSP using an encryption technique including an encrypting function using the TEK and an authentication function. For example, the second communication module 424 encrypts the zone switching ranging response message RNG-RSP using an AES-CCM technique. In the case of encrypting a packet for the zone switching ranging response message RNG-RSP illustrated in FIG. 9A using the AES-CCM technique, the second communication module 424 generates an ICV of the zone switching ranging response message RNG-RSP using a TEK and an initial input variable. In addition, the second communication module 424 encrypts a plaintext payload including the zone switching ranging response message RNG-RSP using the TEK and the initial input variable. Here, the initial input variable includes a MAC header, a PN, length information of a payload to be encrypted, and the like.

The second communication module 424 transmits the encrypted zone switching ranging response message to the mobile station 400 in step 463. For example, the second communication module 424 transmits the encrypted zone switching ranging response message illustrated in FIG. 9B to the mobile station 400. At this point, the second communication module 424 transmits the encrypted zone switching ranging response message using an STID allocated to the mobile station 400 in step 445, or an STID for ranging used during a network initial access.

The second communication module 424 transmits authentication confirm information of the mobile station 400 to the authentication station 430 in step 465.

The mobile station 400 determines whether the encrypted zone switching ranging response message is received from the second communication module 424. For example, the mobile station 400 determines whether the encrypted zone switching ranging response message is received using an STID allocated by the second communication module 424 in step 447. For example, the mobile station 400 determines whether the encrypted zone switching ranging response message is received using an STID for ranging used during a network initial access.

After that, the mobile station 400 determines validity of the encrypted zone switching ranging response message provided from the second communication module 424. For example, the mobile station 400 determines whether an encrypted payload is valid using an ICV included in the encrypted signal provided by the second communication module 424.

When the encrypted payload is valid, the mobile station 400 decodes the encrypted payload. That is, when the encrypted zone switching ranging response message is valid, the mobile station 400 decodes the encrypted zone switching ranging response message. After that, the mobile station 400 determines information for communication with the second communication module 424 from the zone switching ranging response message, and completes the zone switching.

In contrast, when the CMAC is invalid in step 461, the second communication module 424 instructs the mobile station 400 to perform network re-entry. After that, the second communication module 424 and the mobile station 400 perform a network re-entry procedure.

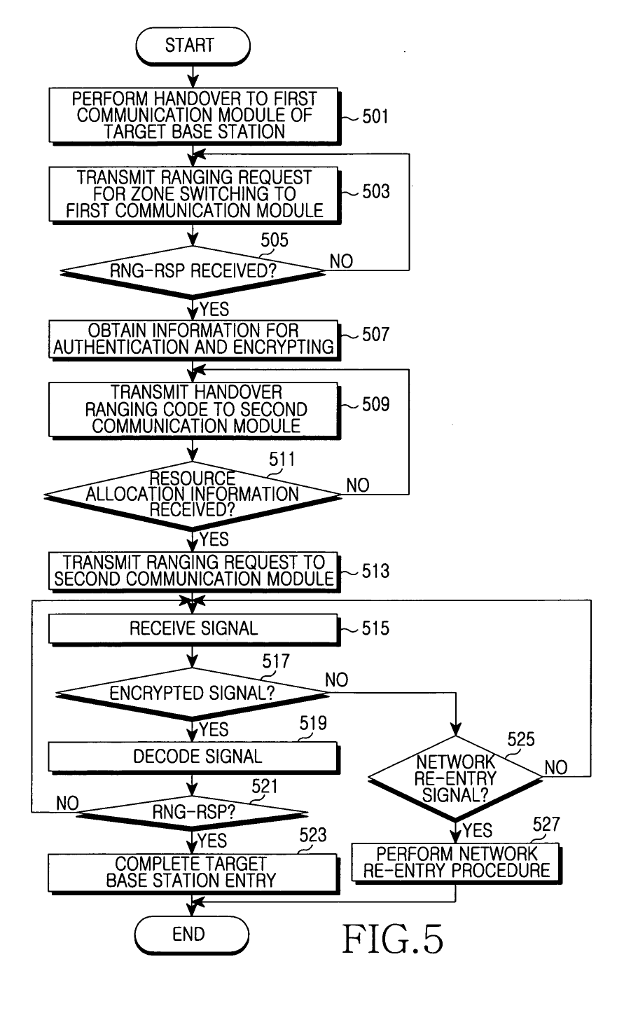

In the case of performing the ranging message authentication process, the mobile station operates as illustrated in FIG. 5. Here, in FIG. 5, it is assumed that the mobile station performs an operation for accessing a target base station that provides a communication service different from that of the mobile station or the serving base station.

FIG. 5 illustrates a procedure for receiving, at a mobile station, authentication from a target base station in a wireless communication system according to an exemplary embodiment of the present invention.

Referring to FIG. 5, in the case where the mobile station performs a handover to a second communication module of a target base station that provides a communication service different from that of the serving base station, the mobile station performs a handover to a first communication module of the target base station that provides the same communication service as that of the serving base station in step 501.

After performing the handover to the first communication module, the mobile station transmits a zone switching ranging request message to the first communication module in order to perform zone-switching to the second communication module in step 503. Here, the zone switching ranging request message includes a CMAC. At this point, the zone switching ranging request message is the same as a handover ranging request message in a network of the same kind.

The mobile station determines whether a zone switching response message is received from the first communication module in step 505.

When the zone switching ranging response message is not received within a set time, the mobile station returns to step 503, and retransmits the zone switching ranging request message to the first communication module. At this point, the mobile station performs retransmission of the zone switching ranging request message up to only a reference transmission frequency.

In contrast, when the zone switching ranging response message is received within the set time, the mobile station obtains information required for communication with the second communication module through the zone switching ranging response message in step 507.

The mobile station transmits a handover ranging code to the second communication module in step 509. For example, the mobile station transmits a ranging code allocated by the second communication module to the second communication module via a resource allocated by the second communication module. For example, the mobile station may transmit a ranging code representing zone switching to the second communication module via a shared resource used in common by mobile stations that try zone switching. That is, the mobile station transmits an arbitrarily selected zone switching code to the second communication module via a zone switching ranging region.

After transmitting the zone switching ranging code, the mobile station determines whether resource allocation information is received from the second communication module in step 511. For example, the mobile station determines whether a zone switching ranging code response message including uplink resource allocation information UL_MAP_IE is received.

When the resource allocation information is not received from the second communication module within a set time, the mobile station returns to step 509 and retransmits a zone switching ranging code to the second communication module. At this point, the mobile station performs retransmission of the zone switching ranging code up to only a reference transmission frequency.

In contrast, when the resource allocation information is received from the second communication module within the set time, the mobile station transmits a zone switching ranging request message RNG-REQ to the second communication module using the uplink resource determined through the resource allocation information in step 513. Here, the zone switching ranging request message includes STID information of the mobile station and a CMAC for authenticating the RNG-REQ message. At this point, the mobile station generates the CMAC using an AK generated using PMK based on an MSK obtained through an EAP, a MAC address of the mobile station, and BSID information of the second communication module. In addition, the STID information of the mobile station includes at least one of a MAC address of the mobile station, a pseudo MAC address of the mobile station, and an STID of the mobile station.

After transmitting the zone switching ranging request message to the second communication module, the mobile station receives a signal from the second communication module in step 515. For example, the mobile station receives a signal including an STID allocated by the second communication module. For example, the mobile station receives a signal including an STID for ranging shared and used during a network initial access.

The mobile station determines whether the signal received from the second communication module in step 515 is an encrypted signal in step 517. For example, the mobile station determines a signal received from the second communication module is an encrypted signal using header information of the received signal.

When the signal received from the second communication module is an encrypted signal, the mobile station decodes the encrypted signal in step 519. For example, the mobile station determines whether the signal is valid using an ICV included in the encrypted signal. When the encrypted signal is valid, the mobile station decodes the encrypted signal. In contrast, when the encrypted signal is invalid, the mobile station discards the signal.

After decoding the encrypted signal, the mobile station determines whether the decoded signal is a zone switching ranging response message in step 521.

When the decoded signal is not a zone switching ranging response message in step 521, the mobile station returns to step 515 and receives another signal from the second communication module.

In contrast, when the decoded signal is a zone switching ranging response message in step 521, the mobile station recognizes that entry to the second communication module has been successful and zone switching has been completed in step 523.

When the signal received from the second communication module is not an encrypted signal in step 517, the mobile station determines whether the signal received from the second communication module is a network re-entry indicate signal in step 525.

When the signal received from the second communication module is not a network re-entry indicate signal, the mobile station returns to step 515 and receives another signal from the second communication module.

In contrast, when the signal received from the second communication module is a network re-entry indicate signal, the mobile station performs a network re-entry procedure for the second communication module in step 527.

After that, the mobile station ends the process.

Hereinafter, a method for operating a base station for encrypting a ranging response message and transmitting the same to a mobile station is described. The following description is made on the assumption that the base station includes at least two communication modules for providing different communication services. At this point, of the communication modules of the base station, a communication module for providing a communication service different from that of a serving base station of a mobile station that requests a handover is described.

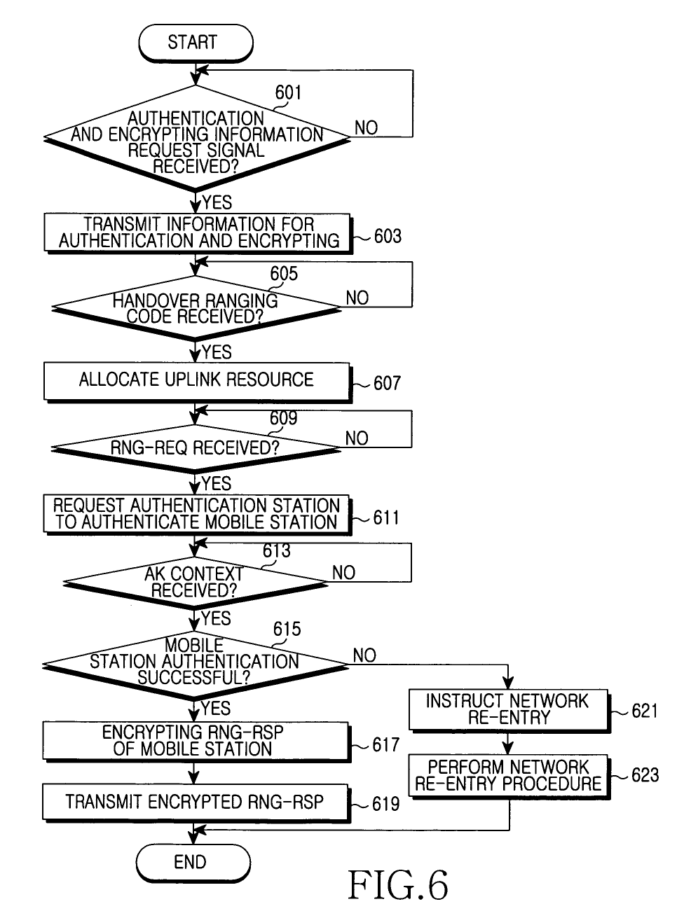

FIG. 6 illustrates a procedure for authenticating, at a base station, a mobile station that performs a handover in a wireless communication system according to an exemplary embodiment of the present invention.

Referring to FIG. 6, a communication module of the base station determines whether an authentication and encryption information request signal is received from a communication module for providing a different communication service in step 601.

When the authentication and encryption information request signal is received, the communication module of the base station transmits the information required for authentication and encryption to the communication module for providing the different communication service/in step 603. Here, the information required for the authentication and the encryption includes nonce information.

The communication module of the base station determines whether a zone switching ranging code is received from a mobile station that performs a handover between networks of different kinds in step 605. For example, the communication module of the base station determines whether a ranging code allocated to the mobile station is received via a resource allocated to the mobile station. For example, the communication module of the base station may determine whether a zone switching ranging code is received via a shared resource used for mobile stations that try an arbitrary access.

When the zone switching ranging code is received from the mobile station, the communication module allocates an uplink resource to the mobile station so that the mobile station may transmit information required for accessing the base station in step 607.

The communication module of the base station determines whether a zone switching ranging request message is received via the uplink resource allocated to the mobile station in step 609. At this point, the zone switching ranging request message includes STID information of the mobile station and a CMAC for authenticating the RNG-REQ message.

When the zone switching ranging request message is not received within a set time, the communication module of the base station determines that an error has occurred. Accordingly, the communication module of the base station returns to step 605 and determines whether a zone switching ranging code is received again. At this point, in the case of receiving the zone switching ranging code more than a reference transmission frequency, the communication module of the base station may recognize that an access of the mobile station has failed.

In contrast, when the zone switching ranging request message is received within the set time, the communication module of the base station requests an authentication station to transmit AK context of the mobile station that has requested the zone switching ranging in step 611.

The base station determines whether an AK response message including AK context of the mobile station is received from the authentication station in step 613. Here, the AK context includes an AK, an AK ID, and AK_COUNT.

When the AK response message is received from the authentication station, the communication module of the base station determines whether a CMAC provided by the mobile station is valid using the AK context included in the AK response message in step 615.

When the CMAC is invalid in step 615, the communication module of the base station determines that the mobile station cannot be authenticated. Accordingly, the communication module of the base station instructs the mobile station to perform network re-entry in step 621.

The communication module of the base station performs a network re-entry procedure of the mobile station in step 623.

In contrast, when the CMAC is valid in step 615, the communication module of the base station determines that the mobile station has been authenticated. Accordingly, the communication module of the base station encrypts a zone switching ranging response message using the AK context included in the authentication response message and a TEK generation variable transmitted (in step 603) to the communication module that provides a different communication service in step 617. For example, the communication module of the base station includes generates a TEK using an AK, a random number, AK_COUNT, a security association ID, a BSID, a MAC address of the mobile station, etc. After that, the communication module of the base station encrypts the zone switching ranging response message using an AES-CCM technique that uses a TEK. That is, the communication module of the base station generates an ICV of the zone switching ranging response message using the TEK and an initial input variable. In addition, the communication module of the base station encrypts a plaintext payload including the zone switching ranging response message using the TEK and the initial input variable. Here, the initial input variable includes a MAC header, a PN, length information of a payload to be encrypted, and the like.

After encrypting the zone switching ranging response message, the communication module of the base station transmits the encrypted zone switching ranging response message to the mobile station in step 619. For example, the communication module of the base station transmits the encrypted zone switching ranging response message using an STID allocated to the mobile station or an STID for ranging used while the mobile station initially accesses a network.

At this point, though not shown, the communication module of the base station transmits authentication confirmation information of the mobile station to the authentication station.

After that, the communication module of the base station ends the process.

Hereinafter, a construction of a mobile station for performing a ranging authentication process for a handover is described.

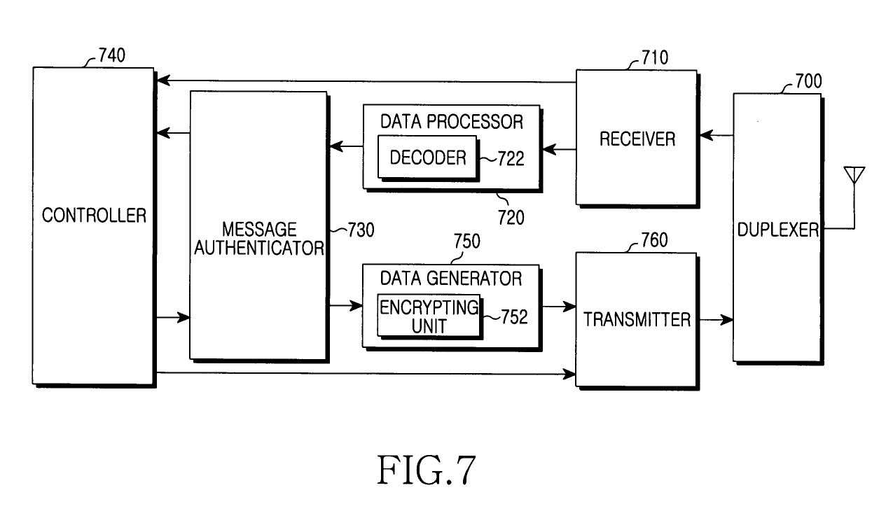

FIG. 7 illustrates a mobile station in a wireless communication system according to an exemplary embodiment of the present invention.

Referring to FIG. 7, the mobile station includes a duplexer 700, a receiver 710, a data processor 720, a message authenticator 730, a controller 740, a data generator 750, and a transmitter 760.

The duplexer 700 transmits a transmission signal provided by the transmitter 760 via an antenna, and provides a reception signal from the antenna to the receiver 710 according to a duplexing scheme. For example, in the case of using Time Division Duplexing (TDD), the duplexer 700 transmits a transmission signal provided by the transmitter 760 via the antenna during a transmission section, and provides a reception signal from the antenna to the receiver 710 during a reception section.

The receiver 710 converts a Radio Frequency (RF) signal provided by the duplexer 700 into a baseband signal, and demodulates and decodes the baseband signal and outputs the same. For example, the receiver 710 includes an RF processing block, a demodulation block, and a channel decoding block. The RF processing block converts an RF signal received via the antenna into a baseband signal. The demodulation block converts the signal provided by the RF processing block into a signal in a frequency domain by performing Fast Fourier Transform (FFT). The channel decoding block may include a demodulator, a deinterleaver, and a channel decoder.

The receiver 710 receives a signal using an STID allocated to the receiver 710. In addition, the receiver 710 provides control information determined through demodulation and decoding to the controller 740, and provides data to the data processor 720.

The data processor 720 detects a packet from data provided by the receiver 710. After that, the data processor 720 determines whether the packet is a control message and whether the control message is encrypted using header information of the detected packet.

When the packet is unencrypted control message, the data processor 720 extracts the control message from the packet and transfers the same to the message authenticator 730.

In contrast, when the packet is an encrypted control message, the data processor 720 transfers the packet to a decoder 722. For example, when the packet is an encrypted handover ranging response message, the data processor 720 transfers the packet to the decoder 722.

The decoder 722 determines validity of the packet using an ICV of the packet provided by the data processor 720. When the packet is invalid, the decoder 722 discards the packet. In contrast, when the packet is valid, the decoder 722 decodes the packet, extracts a control message therefrom, and transfers the control message to the message authenticator 730.

The message authenticator 730 determines whether the control message provided by the data processor 720 is valid. When receiving a control message via the decoder 722, the message authenticator 730 recognizes that the control message is valid. For example, when receiving a handover ranging response message via the decoder 722, the message authenticator 730 recognizes that the handover ranging response message is valid. At this point, the message authenticator 730 recognizes that a target base station that has transmitted the handover ranging response message has been authenticated.

In contrast, when receiving a control message directly from the data processor 720 without the decoder 722, the message authenticator 730 determines validity of the control message using a CMAC included in the control message. At this point, the message authenticator 730 transfers the control message determined as valid to the controller 740.

In addition, when receiving control information requiring message authentication from the controller 740, the message authenticator 730 adds a CMAC to the control information and transfers the same to the data generator 750. For example, when receiving a handover ranging request message from the controller 740, the message authenticator 730 adds a CMAC to the handover ranging request message, and transfers the same to the data generator 750. At this point, the message authenticator 730 generates a CMAC using an AK generated using an MSK obtained through an EAP, a MAC address of the mobile station, and BSID information of a target base station.

The controller 740 controls a handover and a ranging authentication procedure of the mobile station. For example, the controller 740 controls to transmit a control message for moving to a target base station to be accessed through a handover. At this point, in the case of transmitting control information such as a handover ranging code without a packet, the controller 740 controls the transmitter 760 to transmit the control information. In the case of transmitting control information such as a handover ranging request message requiring message authentication, the controller 740 transfers the control information to the message authenticator 730.

For example, when receiving a ranging response message from the message authenticator 730, the controller 740 recognizes that entry to a target base station has been successful and a handover has been completed. When receiving a network re-entry indicate message from the message authenticator 730, the controller 740 controls to perform a network re-entry procedure with the target base station.

The data generator 750 generates and outputs a packet including control information provided by the message authenticator 730. For example, the data generator 750 generates a packet including a handover ranging request message to which a CMAC provided by the message authenticator 730 has been added.

For encryption and transmission of a packet, the data generator 750 encrypts the packet using an encrypting unit 752.

The transmitter 760 converts data provided by the data generator 750 and control information provided by the controller 740 into an RF signal, and transfers the same to the duplexer 700. For example, the transmitter 760 includes a channel-encoding block, a modulation block, and an RF processing block. The channel-encoding block includes a channel encoder, an interleaver, and a modulator. The modulation block converts a signal provided by the modulator into a signal in a time domain by performing Inverse Fast Fourier Transform (IFFT). The RF processing block converts the baseband signal provided by the modulation block into an RF signal, and transfers the RF signal to the duplexer 700.

In the above exemplary embodiment, the controller 740 and the message authenticator 730 are configured independently.

In an exemplary embodiment, the controller 740 and the message authenticator 730 may be incorporated into one module.

Hereinafter, a construction of a base station for encrypting a ranging response message and transmitting the same to a mobile station is described.

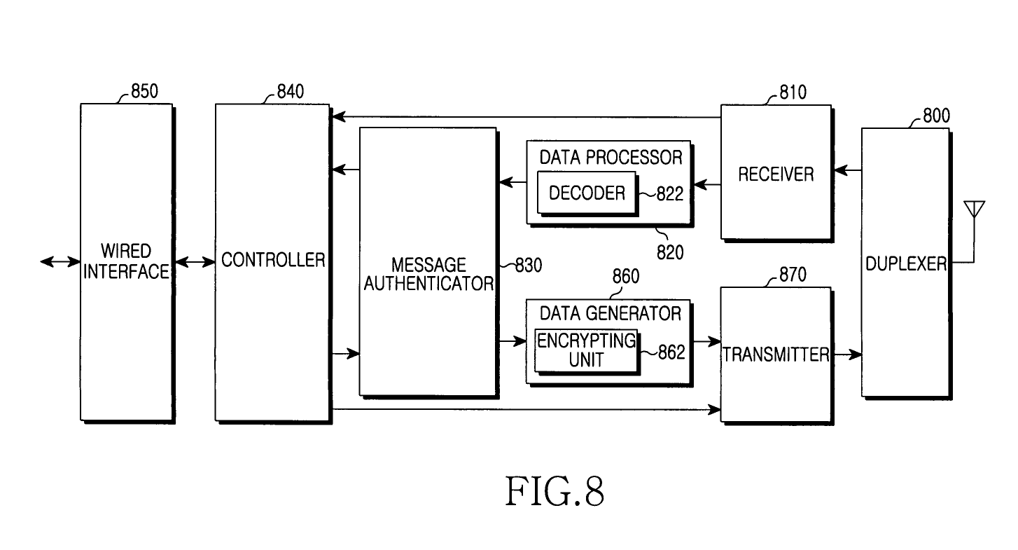

FIG. 8 illustrates a base station in a wireless communication system according to an exemplary embodiment of the present invention.

Referring to FIG. 8, the base station includes a duplexer 800, a receiver 810, a data processor 820, a message authenticator 830, a controller 840, a wired interface 850, a data generator 860, and a transmitter 870.

The duplexer 800 transmits a transmission signal provided by the transmitter 870 via an antenna, and provides a reception signal from the antenna to the receiver 810 according to a duplexing scheme. For example, in the case of using Time Division Duplexing (TDD), the duplexer 800 transmits a transmission signal provided by the transmitter 870 via the antenna during a transmission section, and provides a reception signal from the antenna to the receiver 810 during a reception section.

The receiver 810 converts an RF signal provided by the duplexer 800 into a baseband signal, and demodulates and decodes the baseband signal and outputs the same. For example, the receiver 810 includes an RF processing block, a demodulation block, and a channel decoding block. The RF processing block converts an RF signal received via the antenna into a baseband signal. The demodulation block converts the signal provided by the RF processing block into a signal in a frequency domain by performing FFT. The channel decoding block may include a demodulator, a deinterleaver, and a channel decoder.

At this point, the receiver 810 provides control information determined by demodulation and decoding to the controller 840, and provides data to the data processor 820. For example, the receiver 810 provides a handover ranging code to the controller 840, and provides a handover ranging request message to the data processor 820.

The data processor 820 detects a packet from data received from the receiver 810. After that, the data processor 820 determines whether the packet is a control message and whether the control message is encrypted using header information of the detected packet.

When the packet is an unencrypted control message, the data processor 820 extracts a control message from the packet and transfers the control message to the message authenticator 830. For example, when the packet is an unencrypted handover ranging request message, the data processor 820 extracts a handover ranging request message from the packet, and transfers the same to the message authenticator 830.

In contrast, when the packet is an encrypted control message, the data processor 820 transfers the packet to a decoder 822. The decoder 822 determines validity of the packet using an ICV of the packet provided by the data processor 820. When the packet is invalid, the decoder 822 discards the packet. In contrast, when the packet is valid, the decoder 822 decodes the packet, extracts a control message therefrom, and transfers the extracted control message to the message authenticator 830.

The message authenticator 830 determines whether the control message provided by the data processor 820 is valid. When receiving a control message via the decoder 822, the message authenticator 830 recognizes that the control message is valid. In contrast, when receiving a control message directly from the data processor 820 without the decoder 822, the message authenticator 830 determines validity of the control message using a CMAC included in the control message. For example, when receiving a handover ranging request message from the data processor 820, the message authenticator 830 requests the controller 840 to provide AK context of a mobile station that has requested handover ranging. After that, when receiving the AK context from the controller 840, the message authenticator 830 determines whether a CMAC included in the handover ranging request message is valid using the AK context. At this point, the message authenticator 830 recognizes that the mobile station that has transmitted the handover ranging request message has been authenticated. Here, the AK context includes an AK, an AK ID, and AK COUNT.

The message authenticator 830 transfers a control message determined as valid to the controller 840.

In addition, when receiving control information requiring message authentication from the controller 840, the message authenticator 830 adds a CMAC to the control information and transfers the same to the data generator 860.

The controller 840 controls a handover and a ranging. authentication procedure of the mobile station that requests a handover. For example, when receiving a handover ranging code from the receiver 810, the controller 840 detects an access trial of the mobile station. Accordingly, the controller 840 allocates an uplink resource to the mobile station so that the mobile station may transmit information required for accessing the base station.

In addition, when the message authenticator 830 requests an AK of the mobile station that has requested handover ranging, the controller 840 requests an authentication station to transmit AK context of the mobile station via the wired interface 850. After that, the controller 840 transfers the AK context provided by the authentication station via the wired interface 850 to the message authenticator 830.

In addition, when receiving a handover ranging request message from the message authenticator 830, the controller 840 generates a handover ranging response message and provides the same to the message authenticator 830.

The data generator 860 generates and outputs a packet including control information provided by the message authenticator 830.

For encryption and transmission of a packet, the data generator 860 encrypts the packet using an encrypting unit 862. For example, when receiving a handover ranging response message from the message authenticator 830, the encrypting unit 862 generates a TEK using an AK and a TEK generation variable provided by the message authenticator 830. That is, the encrypting unit 862 generates a TEK using an AK, a random number, AK_COUNT, a security association ID, a BSID, a MAC address of a mobile station, and the like.

After that, the encrypting unit 862 encrypts a handover ranging response message RNG-RSP using an encryption technique including an encrypting function using a TEK and an authentication function. For example, the encrypting unit 862 encrypts a handover ranging response message using the AES-CCM technique. In the case of encrypting a handover ranging response message illustrated in FIG. 9A, the encrypting unit 862 generates an ICV of the handover ranging response message using the TEK and an initial input variable. In addition, the encrypting unit 862 encrypts a. planetext payload including a handover ranging response message using the TEK and the initial input variable. Here, the initial input variable includes a MAC header, a PN, length information of a payload to be encrypted.

The transmitter 870 converts data provided by the data generator 860 and control information provided by the controller 840 into an RF signal, and transfers the same to the duplexer 800. For example, the transmitter 870 includes a channel-encoding block, a modulation block, and an RF processing block. The channel-encoding block includes a channel encoder, an interleaver, and a modulator. The modulation block converts a signal provided by the modulator into a signal in a time domain by performing the IFFT. The RF processing block converts the baseband signal provided by the modulation block into an RF signal, and transfers the RF signal to the duplexer 800.

In the above exemplary embodiment, the controller 840 and the message authenticator 830 are configured independently.

In an exemplary embodiment, the controller 840 and the message authenticator 830 may be incorporated into one module.

As described above, a base station of a wireless communication system encrypts a ranging response message and transmits the same to a mobile station that performs a handover, so that information exposure of the mobile station that performs a handover between networks of different kinds, or a handover between networks of the same kind may be prevented. In addition, since a separate message for security is not required during a handover procedure, a security level may be raised without an increase of a handover delay time.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for authenticating a ranging message at a mobile station of a wireless communication system, the method comprising:
requesting ranging to a base station to be accessed through a handover;
when an encrypted ranging response message is received from the base station, determining validity of the encrypted ranging response message using an Integrity Check Value (ICV) of the encrypted ranging response message; and
when the encrypted ranging response message is valid, decoding the encrypted ranging response message.

2. The method of claim 1, further comprising, prior to the requesting of the ranging, transmitting a handover ranging code to the base station.

3. The method of claim 1, wherein the requesting of the ranging comprises transmitting a ranging request message comprising a Station Identifier (STID) of the mobile station and a Cipher-based Message Authorization Code (CMAC) to the base station.

4. The method of claim 1, further comprising, when the encrypted ranging response message is invalid, discarding the encrypted ranging response message.

5. The method of claim 1, further comprising, prior to the requesting of the ranging:
when the base station comprises at least two communication modules that provide different communication services, performing a handover to a first communication module of the base station that provides the same communication service as that of a serving base station that has been accessed before the handover to the base station; and
transmitting a ranging request message for zone-switching to the first communication module,
wherein the requesting of the ranging comprises, when a response message to the ranging request message for zone-switching is received from the first communication module, requesting ranging to a second communication module of the base station.

6. A method for authenticating a ranging message at a base station of a wireless communication system, the method comprising:
when a ranging request message is received from a mobile station that performs a handover, requesting an authentication station to transmit Authorization Key (AK) context of the mobile station;
determining validity of the ranging request message using CMAC based on the AK context of the mobile station received from the authentication station;
when the ranging request message is valid, encrypting a ranging response message to the ranging request message; and
transmitting the encrypted ranging response message to the mobile station.

7. The method of claim 6, further comprising:
when a handover ranging code is received from the mobile station before the requesting of the authentication of the mobile station, allocating an uplink resource so that the mobile station performs ranging; and
determining whether a ranging request message is received from the mobile station via the uplink resource allocated to the mobile station.

8. The method of claim 6, wherein the AK context comprises at least one of an Authorization Key (AK), an AK ID, and AK_COUNT.

9. The method of claim 6, wherein the encrypting of the ranging response message comprises:
generating a Traffic Encryption Key (TEK) using a TEK generation variable for encryption communication with the mobile station provided by the authentication station;
generating an Integrity Check Value (ICV) of the ranging response message using the TEK; and
encrypting the ranging response message using the TEK.

10. The method of claim 6, further comprising, when the base station comprises at least two communication modules that provide different communication services, transferring, at a first communication module, authentication and encrypting information to a second communication module in response to a request of the second communication module before a ranging request message is received from the mobile station,
wherein the first communication module provides a communication service different from that of a base station before the handover of the mobile station, and comprises a communication module configured to allow an access of the mobile station through the handover, and
the second communication module comprises a communication module configured to provide the communication service as that of the base station before the handover of the mobile station.

11. An apparatus for authenticating a ranging message at a mobile station of a wireless communication system, the apparatus comprising:
a transmitter configured to transmit a ranging request message to a base station to be accessed through a handover;
a receiver configured to receive a signal from the base station;
a data processor configured to, when an encrypted ranging response message is received via the receiver, determine validity of the encrypted ranging response message using an Integrity Check Value (ICV) of the encrypted ranging response message; and
a controller configured to control to transmit a ranging request message to the base station, and determining whether a handover to the base station is completed depending on validity of the ranging response message determined by the data processor.

12. The apparatus of claim 11, wherein the transmitter transmits a handover ranging code to the base station, and transmits the ranging request message to the base station via the ranging code using a resource allocated by the base station.

13. The apparatus of claim 11, wherein the transmitter transmits the ranging request message comprising a Station Identifier (STID) of the mobile station and a Cipher-based Message Authorization Code (CMAC) to the base station.

14. The apparatus of claim 11, wherein the data processor comprises a decoder configured to determine a validity of the encrypted ranging response message, when the encrypted ranging response message is valid, decode the encrypted ranging response message, and extract a control message.

15. The apparatus of claim 11, further comprising a message authenticator configured to transfer a control message determined as valid by the data processor, to the controller, determine validity of an unencrypted control message provided by the data processor, and transfer a control message determined as valid to the controller.

16. An apparatus for authenticating a ranging message at a base station of a wireless communication system, the apparatus comprising:
a receiver configured to receive a signal;
a transmitter configured to transmit a signal;
a wired interface configured to perform communication with an authentication station;
a message authenticator configured to, when a ranging request message is received from a mobile station through the receiver, determine validity of the ranging request message using Authorization Key (AK) context of the mobile station provided from a controller;
the controller configured to obtain the AK context of the mobile station from the authentication station via the wired interface in response to a request of the message authenticator, and when the message authenticator determines the ranging request message is valid, controlling to transmit a ranging response message to the mobile station; and
a data generator configured to encrypt a ranging response message provided from the message authenticator and transmitting the same to the mobile station via the transmitter under control of the controller.

17. The apparatus of claim 16, wherein when a handover ranging code is received from the mobile station via the receiver, the controller allocates an uplink resource so that the mobile station performs ranging.

18. The apparatus of claim 16, wherein the message authenticator determines whether a Cipher-based Message Authorization Code (CMAC) included in the ranging request message is valid using the AK context comprising at least one of an Authorization Key (AK), an AK ID, and AK_COUNT.

19. The apparatus of claim 16, wherein the data generator generates a Traffic Encryption Key (TEK) using a TEK generation variable for encryption communication with the mobile station provided by the authentication station, generates an Integrity Check Value (ICV) of the ranging response message using the TEK, and encrypts the response message using the TEK.

20. The apparatus of claim 16, wherein when the base station comprises at least two communication modules configured to provide different communication services, a controller of a first communication module configured to transfer authentication and encrypt information to a second communication module via the wired interface in response to a request of the second communication module,
the first communication module is configured to provide a communication service different from that of a base station before a handover of the mobile station, and comprises a communication module configured to allow an access of the mobile station through the handover, and
the second communication module comprises a communication module configured to provide the communication service as that of the base station before the handover of the mobile station.
